(19) United States
(12) Patent Application Publication
(10) Pub. No.: US 2013/0316091 A1
(43) Pub. Date: Nov. 28, 2013

(54) MULTI-LAYER PRINTING PROCESS

(71) Applicant: AMCOR GROUP GMBH, Zurich (CH)

(72) Inventors: ALAIN WITTMANN, Dombresson (CH); Ron Perry, Thomaston, GA (US); Hans Weber, Reiden (CH)

(73) Assignee: Amcor Group GMbH, Zurich (CH)

(21) Appl. No.: 13/786,718

(22) Filed: Mar. 6, 2013

Related U.S. Application Data
(60) Provisional application No. 61/651,111, filed on May 24, 2012.

(51) Int. Cl. B05D 5/00

(52) U.S. Cl. CPC B05D 5/00
USPC 427/552; 427/265; 427/558

(57) ABSTRACT

A process for forming a printed product that includes applying an energy-hardenable varnish to a sheet-like substrate at a first station; conveying the substrate to a hardening device where the outermost surface of the varnish is applied against a smooth polishing surface that smoothens it during its passage through the hardening device; hardening the layer of varnish typically by UV or EB curing; and applying metalized ink by a printing process to the smoothened surface of the layer of varnish.

### CROSS-REFERENCE TO RELATED APPLICATIONS

This application claims the benefit of U.S. Provisional Application No. 61/651,111, filed on May 24, 2012. The entire disclosure of the above application is incorporated herein by reference.

### FIELD

The present disclosure relates to multi-layer printing processes and, more particularly, relates to a multi-layer printing processes and resultant product that employs an energy curable/hardenable coating that provides advantages over conventional hot/cold foil stamping.

### BACKGROUND

This section provides background information related to the present disclosure which is not necessarily prior art.

In the printing and/or manufacturing industries, it is often desirable to print or otherwise apply indicia to a product container or other packaging. Traditionally, selection of the application process would revolve around the physical characteristics of the final indicia. In some applications, durability of the indicia was paramount (e.g. resistance to scuffing or damage). In some applications, appearance of the indicia was paramount (e.g. reflectivity). In some applications, durability, appearance, and/or other characteristics were desirable.

Conventionally, foil stamping, also known as hot foil stamping, hot stamping, dry stamping, cold foil stamping, foil imprinting, and leaf imprinting, was used to achieve a desired appearance in the final product. Generally speaking, hot stamping is a dry printing method in which a heated die and foil are used to apply graphics to a target surface. The process of hot stamping generally comprises heating a die defining a desired shape for the transfer, applying a metallic foil over the target surface, and, through a combination of heat, dwell time, and pressure, a partial transfer of the metallic foil, in the shape of the die, is transferred and bonded to the target surface.

Hot/cold foil stamping is often desirable because of it being a dry process that does not employ solvents or inks, and does not typically result in harmful vapors.

However, the quality of the foil stamping process is highly dependent on the quality of the fixture or anvil used to support the part to be printed. That is, the fixture must be supportive to reliably and repeatably position the part to be printed. Variation in either may compromise the quality of the stamping process.

It should be recognized that conventional foil stamping often requires substantial investment in machinery that is both cumbersome and costly.

Rotary hot/cold foil stamping can improve the processing rate of conventional foil stamping as it reduces the dwell time. This can, in turn, improve the resultant detail of the indicia. However, use of the rotary hot foil stamping system can be challenging in terms of trying to maintain the desired temperature of the die. In all cases, the die must be held securely in position in order to produce even depth of impression through heavy and light coverage regions of the die.

Unfortunately, there are limits to the complexity of foil stamping indicia. For example, foil stamping can be limited to specific surface topography. Moreover, foil stamping can be costly compared to ink printing.

Conventional ink printing, however, generally requires application of a printing ink on to the target surface and then is typically followed with application of a lacquer or other protective layer to enhance the appearance of the indicia (e.g. reflectivity) and protect the indicia. Unfortunately, conventional ink printing is not able to achieve the ultimate appearance of foil stamping; that is, conventional ink printing cannot generally achieve the reflectivity of foil printing.

### SUMMARY

This section provides a general summary of the disclosure, and is not a comprehensive disclosure of its full scope or all of its features.

In accordance with the present teachings, a novel multi-layer ink printing process is provided that overcomes the deficiencies of conventional ink printing and is capable of at least matching, and in some embodiments surpassing, the appearance and durability of foil stamping.

According to a main aspect of the invention, there is provided a process for forming a printed product comprising the following features:
(a) Applying a hardenable varnish to a sheet-like substrate at a first printing station to form a non-hardened layer of varnish on the substrate, said layer of varnish having an outermost surface relative to the substrate;
(b) conveying the substrate with the layer of varnish to a hardening device where said outermost surface of the varnish (cured directly as the surface is delivered from the printing process) is applied against a smooth polishing surface that conforms to said outermost surface of the layer of varnish and smoothens said outermost surface of the layer of varnish applied to the substrate during its passage through the hardening device after the first printing station;
(c) hardening the layer of varnish, the hardening being accomplished during its passage through said hardening device, optionally as partial hardening immediately upstream of said hardening device after the first printing station and optionally as partial hardening to complete hardening immediately downstream of said hardening device;
(d) conveying the substrate with its applied hardened layer of varnish that is smoothened on said outermost surface to a second printing station; and
(e) at the second printing station, applying metalized ink by a printing process to said smoothened outermost surface of the layer of varnish applied on the substrate.

In particular embodiments of the present disclosure, the substrate is paper or board, i.e. with a relatively rough surface, and the varnish is an energy-hardenable varnish, in particular an EB- or UV-curable varnish, that is hardened by being cured respectively by applying an electron beam or ultra-violet radiation which creates a polymerization of the varnish.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustration of a printing system usable in the present teachings;

FIG. 1A is a diagrammatic view of a conventional curing arrangement for curing a varnish layer on a substrate;

FIG. 2A is a schematic cross-sectional view illustrating a product made in accordance with the multi-layer printing process of the present teachings according to some embodiments;

FIG. 2B is a schematic cross-sectional view illustrating a product made in accordance with the multi-layer printing process of the present teachings according to some embodiments;

FIG. 3 is a schematic cross-sectional view illustrating a conventional foil stamping product;

FIG. 4 is a diagrammatic view of a first example of a curing/hardening device of the inventive process where the outermost surface of the layer of varnish is smoothened and where the layer of varnish is cured; and

FIGS. 5 to 7 show further examples of a curing/hardening device of the inventive process where the outermost surface of the layer of varnish is smoothened in different fashions and where the layer of varnish is cured in the hardening device or adjacent thereto.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

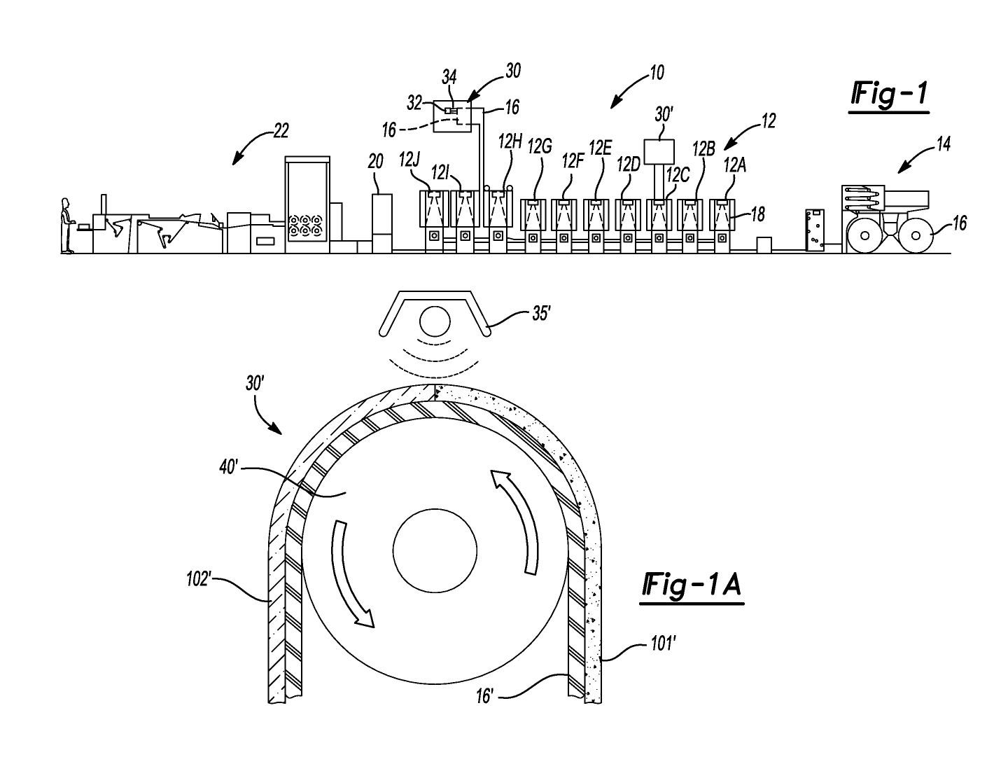

With particular reference to FIG. 1, a printing system 10 is provided according to the principles of the present teachings. In some embodiments, printing system 10 is based on a rotogravure (also known as a gravure) printing system. The system is generally an intaglio-type printing system that involves engraving the image onto an image carrier. In gravure printing, the image is engraved onto a cylinder for use in a rotary printing press configuration. However, it should be appreciated that the principles of the present teachings are not limited to only gravure type printing systems and are equally applicable to flexographic printing and the like. In flexographic printing, ink is transferred from a fountain roller to a flexible plate cylinder by a so-called anilox roller that meters the ink.

Generally speaking, the gravure process system is configured by first creating one or more cylinders with an engraved image to be printed. Engraving of the image on the cylinder can be accomplished according to any one of a number of techniques, including physical engraving (e.g. via a diamond stylus), etching (e.g. chemical etching), direct laser engraving and the like. This engraved image is sized to contain the printing ink to be transferred to the substrate. In some embodiments, the substrate can comprise paper or other fibrous material, such as stock, cardboard, corrugated board, polyethylene, polypropylene, polyester, BOPP and the like. It should be noted, however, that alternative substrate materials can be used that are conventional in the art. As noted above, the invention is particularly advantageous for fibrous substrates such as paper or board that present a relatively rough surface. Boards usable in the invention typically have a grammage from about 160 g/m² to about 400 g/m², often in the range 180 to 280 g/m². This corresponds to a thickness in the range of about 180 to 400μ depending on the density of the board material. Paper substrates range typically from about 80 g/m² to about 160 g/m².

Generally, printing system 10 can comprise a plurality of stations 12, such as a first station 12A, a second station 12B, a third station 12C, a fourth station 12D, a fifth station 12E, a sixth station 12F, a seventh station 12G, an eighth station 12H, a ninth station 12I, and a tenth station 12J. It should be appreciated that printing system 10 can be configured with fewer or greater number of stations; however, the present embodiment represents at least one preferred embodiment. In some embodiments, each of the plurality of stations 12 can be configured for a different purpose, such as application of an energy curable ink (which will be discussed more completely herein), a different color, a different coating, or the like. In this regard, any one of a number of layering and processing patterns can be achieved on the substrate.

In some embodiments, printing system 10 can comprise a feed system 14 for supplying and feeding a substrate to be printed or web 16, such as paper, stock, cardboard, corrugated board, polyethylene, polypropylene, polyester, BOPP and the like, to each of the plurality of stations 12. Each of the plurality of stations 12 can comprise a printing cylinder 18 disposed therein. However, it should be recognized that each of the illustrated stations 12 do not require the use of a printing cylinder 18 as such station may be used for alternative purposes in some embodiments.

In some embodiments, printing system 10 can further comprise an optional inspection station 20. Inspection station 20 can be disposed in a downstream position relative to the plurality of stations 12. Inspection station 20 can automatically check and/or continually check the quality, rate, and condition of the now-printed substrate 16 and the resultant indicia contained thereon. The now-printed substrate 16 can then be final processed and palletized, if desired, in finishing station 22. Finishing station 22 can accomplish any one of a number of processing functions, such as creasing, die cutting, palletizing, and the like.

The printing system 10 further comprises at least one curing/hardening station 30. Curing station 30, in some embodiments, can be used for curing an energy curable ink deposited on substrate 16. According to some teachings of the present application, curing station 30 can comprise a beam unit 32 outputting an energy beam 34, such as an electron beam and/or an ultraviolet beam, directed at substrate 16. In some embodiments, a current can be placed across a filament causing electrons to be accelerated off the filament. These electrons can be used with an energy curable ink, such as an energy curable metallic ink, to cause a polymerization in the ink (herein referred to as EB curing). Beam unit 32 can comprise nitrogen to ensure the curing environment is inert, if desired. UV curing can also be under atmospheric condition. EB curing typically does not generate much heat and is therefore beneficial in many applications. However, as mentioned, UV curing can also be used in accordance with the present teachings, although they should not be regarded as obvious variants of each other as various technical and procedural differences exist between the two.

EB curing generally employs high-energy electrons. These electrons are generally not affected by the thickness of printing inks or the color of the ink. The electron beam 34 provides sufficient energy to cure thick coatings and/or pass through other substrates.

The energy curable ink/varnish of the present teachings can comprise, in some embodiments, an acrylate material that cures by free radical polymerization. Therefore, unlike other curing systems, a photoinitiator is not required. The electron energy is sufficient to cause the acrylate materials to polymerize by opening the acrylate bonds to form free radicals. These radicals then attack the remaining acrylate bonds until the reaction reaches completion. The result is a cured layer upon the substrate that is durable and provides previously-unattained reflectivity and optical characteristics using an ink-type application. In addition to energy-curable ink/varnish, the invention also applies to other hardenable materials. An example is over-printable wax. Wax is cured/hardened by cooling melted wax.

FIG. 1A illustrates a prior device 30′ for curing a varnish layer, wherein a substrate 16′ typically of board, and its applied UV-curable varnish layer 101′ that is applied by an upstream flexographic printing station, for example, are passed around a cylinder 40′ such that varnish layer 101′ faces outwardly. As the varnish layer 101′ passes around the cylinder 40′, it is exposed to UV radiation from an external UV lamp 35′. This cures the varnish so a layer of cured varnish 102′ leaves the cylinder 40′.

### Process

While the printing system 10 is in operation, the engraved cylinder 18 is partially immersed in the ink fountain, filling the recessed cells with energy curable ink, conventional ink, and/or the like. As the cylinder rotates, it draws ink out of the fountain with it. Acting as a squeegee, a doctor blade scrapes the cylinder before it makes contact with the substrate, removing excess ink from the non-printing (non-recessed) areas and leaving in the cells the right amount of ink required. Next, the substrate gets sandwiched between the impression roller and the gravure cylinder, thereby transferring the ink to the substrate. The purpose of the impression roller is to apply force, pressing the substrate onto the gravure cylinder, ensuring even and maximum coverage of the ink. The capillary action of the substrate and the pressure from impression rollers force the ink out of the cell cavity and transfer it to the substrate. The substrate can then proceed to a dryer to completely dry before application of the subsequent layer.

The substrate 16 can include application of the energy curable ink/varnish at one or more of the plurality of stations 12. For example, the eighth station 12H can include application of an energy curable ink to substrate 16. Substrate 16 can continue its downstream processing, and be directed to curing station 30 (procedurally between eighth station 12H and ninth station 12I, whereby beam unit 32 outputs electron beam 34 directed at the energy curable ink from station 12H. Application of electron beam 34 to energy curable ink on substrate 16 (the EB coating) causes a polymerization or other curing process of energy curable ink. In some embodiments, several layers of coatings can be cured down to a single layer. As a result of this process, the energy curable ink is thus bonded or otherwise cured to substrate 16. It has been found that this process produces a resultant indicia (made from the now-cured energy curable ink) that can be tailored to provide any one of a number of reflectivity characteristics up to at least a mirror finish, as described below. In this way, the results of the present process are at least equivalent to foil stamping, but with additional flexibility. Moreover, the durability of the finish composition, in many applications, is sufficient so as to avoid the need for any additional layers or protective coatings, such as lacquer and the like.

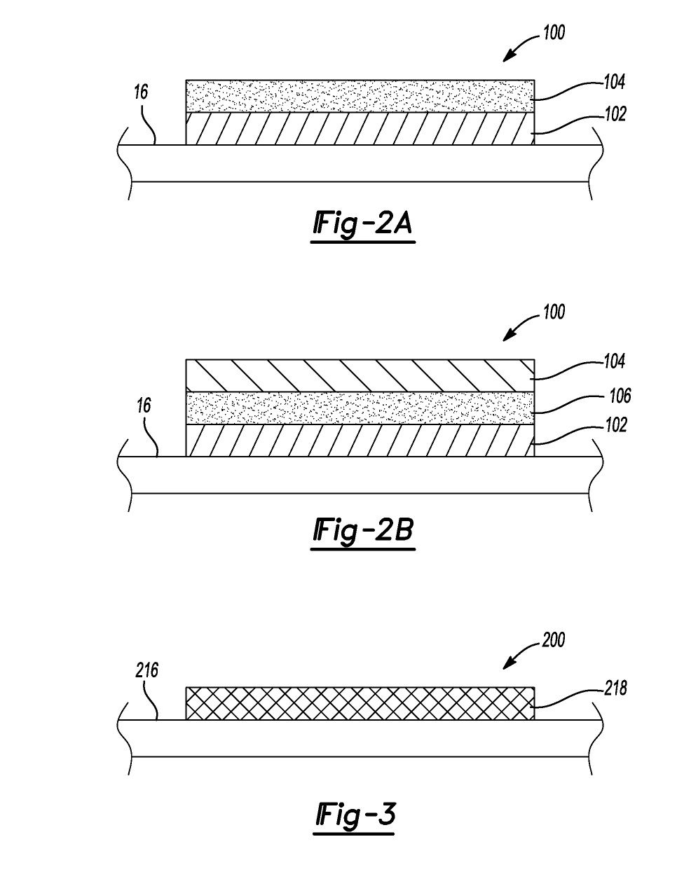

As a result of the aforementioned process, a product 100 is illustrated in FIG. 2A having a substrate 16, an energy cured layer 102, and an optional overcoat layer (e.g. lacquer) 104. In some embodiments as illustrated in FIG. 2B, product 100 can comprise substrate 16, an energy cured layer 102, a metallic ink layer 106 applied above energy cured layer 102, and an optional overcoat layer 104 disposed above metallic ink layer 106. In contrast, a conventional foil stamped product 200 illustrated in FIG. 3 having a substrate 216 and a foil stamping 218.

A metallic ink layer 106 (FIG. 2B) can be applied to the now-cured energy cured layer 102 to provide a high finish quality at station 12I or 12J. In some embodiments, the metallic ink used for metallic ink layer 106 can be conventional metallic ink that is available in an assortment of colors. It has been found that application of metallic ink layer 106 to the energy cured layer 102 creates a bond therebetween that results in increased durability of metallic ink layer 106 relative to conventional application of metallic ink layers. In some embodiments, an overcoat layer, which will be discussed herein, may not be required to protect metallic ink layer 106. Moreover, the finish quality of the metallic ink layer 106 (being disposed upon energy cured layer 102) is enhanced (e.g. improved reflectivity) compared to metallic ink layers deposited directly on a substrate according to conventional processes.

In further embodiments, if desired, a lacquer or overcoat layer can be applied to the now-cured energy cured layer 102 and metallic ink layer 106 to provide a high finish quality at station 12I or 12J and/or enhance durability. Notwithstanding, however, it has been found that because of the high finish quality provided by cured energy cured layer 102 and metallic ink layer 106, application of this overcoat layer (see 104 of FIGS. 2A and 2B) is often not needed to enhance finish quality and, in some cases, application of this overcoat layer may in fact reduce the overall finish quality because of the high native quality of the energy cured layer 102. Moreover, in such applications that do not employ a lacquer or overcoat layer, the durability of the energy cured layer is often sufficient for many, if not all, applications.

Similar to curing station 30 positioned between stations 12H and 12I, curing station 30′, having a similar construction, can be positioned between any other of the plurality of stations 12, such as between third station 12C and fourth station 12D. In such embodiments, additional or alternative energy cured coating layers can be applied and subsequently cured in curing station 30′.

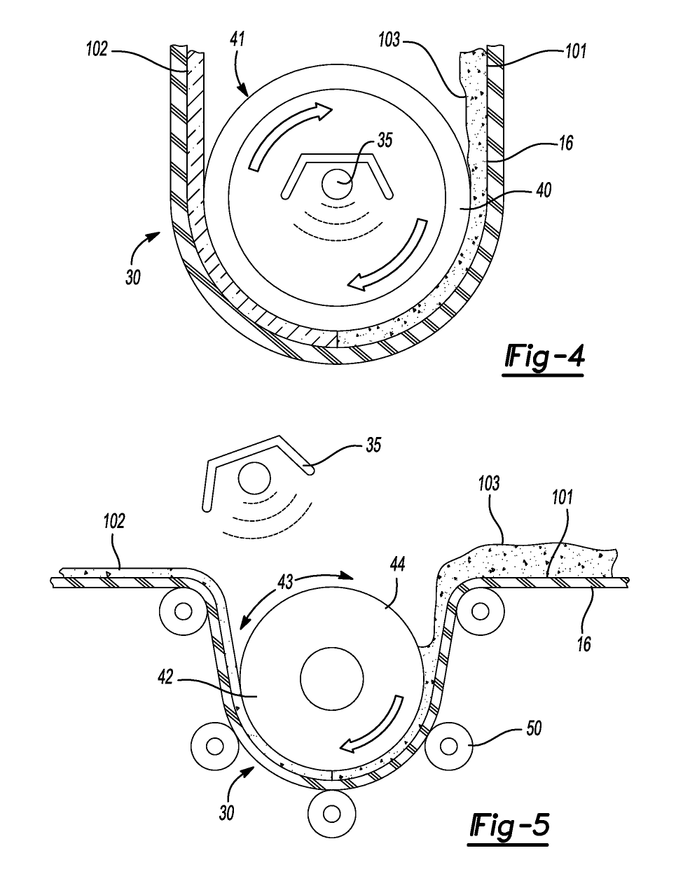

FIG. 4 schematically shows an example of a curing device 30 of the inventive process, wherein a substrate 16 and its applied UV-curable varnish layer 101 are passed around a hollow quartz cylinder 40 having a smooth polishing outer surface 41 against which the outermost surface 103 of the varnish layer 101 is applied to, contacts or otherwise engages with smoothen surface 103 as it passes around cylinder 40. During its passage around cylinder 40, the varnish layer 101 is held pressed against the cylinder's smooth polishing outer surface 41 by tension from the substrate 16 which is located on the outside relative to the cylinder 40.

As shown in FIG. 4, a UV lamp 35 forming an energy source for applying energy to harden the varnish layer 101 is located inside the cylinder 40 which is transparent to the applied energy. In this example, the UV energy is applied to the layer of varnish 101 through the walls of the hollow cylinder 40. Thus, as the layer of uncured varnish 101 progresses around the cylinder, it is cured as it passes the location of the UV lamp such that a fully cured layer 102 of varnish leaves the cylinder 40 and exits the curing/hardening device 30.

With this FIG. 4 example, spot varnishing is possible, i.e. varnishing small selected areas.

FIG. 5 shows a modification of FIG. 4, wherein a UV lamp 35 constituting an energy source for applying energy to harden the varnish layer 101 is located outside a solid quartz cylinder 42, namely beside its open upper part 43. In this example, the UV radiation passes right though the solid quartz cylinder 42.

FIG. 5 also shows a plurality of rollers 50 applying against the outer surface 103 of the substrate 16 to guide it around the cylinder 42 and thereby apply the outermost surface 103 of the varnish layer 101 against the smooth outer surface 44 of the cylinder 42 as it passes therearound.

Also with this FIG. 5 example, spot varnishing is possible, i.e. varnishing small selected areas.

In a non-illustrated variation of FIG. 4, the internal UV lamp 35 is replaced by an external EB source and the varnish is an EB-curable varnish. In this variation, an electron beam is applied to the layer of varnish 101 from outside, through the substrate 16. This variation is only appropriate for thin substrates that will not produce a substantial energy loss of the electron beam as it passes through the substrate.

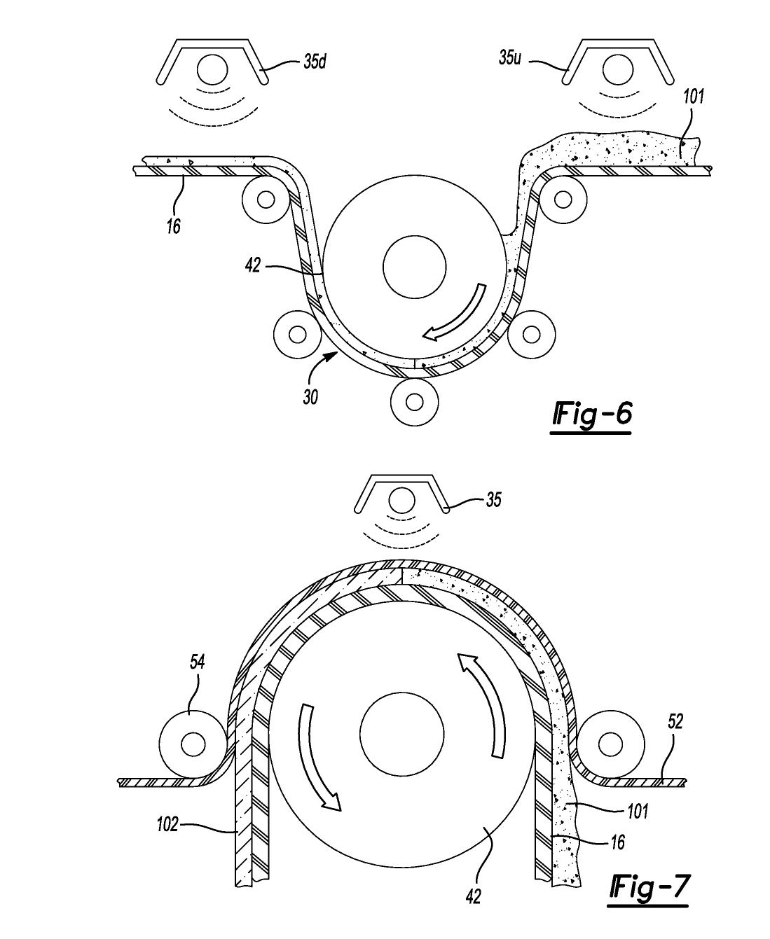

FIG. 6 shows a modification of FIG. 5, wherein instead of having a single UV lamp 35 acting through the cylinder 42, there is a first UV lamp 35u as energy source for applying energy to partially harden the varnish layer 101, which is located before the curing/hardening device 30, and a second UV lamp 35d as energy source for applying energy to fully harden the varnish layer 101, which is located after the curing/hardening device 30. In this way, the UV-curable varnish will be pre-cured before the curing/hardening device 30, in such a way that is sticks on the substrate 16 but is still soft enough to be calendered/smoothened during its passage over cylinder 42. The soft pre-cured varnish will be squeezed onto the highly smooth polishing surface of the calendar cylinder 42, in this example, final curing of the varnish 101 occurs after it has left the cylinder 42, just downstream of the curing/hardening device 30.

In FIG. 7, the substrate 16 and its applied varnish layer 101 are passed around a cylinder 42 at the second station with the outermost surface of the varnish layer 101 located outside relative to cylinder 42, and wherein a smooth transparent film 52 or a silicon belt is applied to the outside of said outermost surface of the varnish layer 101 to smoothen it.

The smooth film 52 is applied against said outermost surface by rollers 54 located substantially diametrically of the cylinder 42 and, between the rollers 54, the film 52 is held against said outermost surface by tension. Typically, the smooth thin film 52 can circulate in a closed loop.

As shown in FIG. 7, a UV lamp 35 as energy source for applying energy to harden the varnish layer 101 is located outside the cylinder 42 such that the UV energy is applied to the layer of varnish 101 from outside through the smooth film 52 or the silicon belt. In this example, the substrate 16 is fed onto the outer surface of a cylinder 42, with the uncured varnish layer 101 facing out. As shown, when the layer 101 of uncured varnish comes into contact with the thin film 52 as it passes around roller 54, it is compressed and smoothened by its contact with the thin film 52 as the varnish layer 101 passes around cylinder 42. At the location of the UV lamp 35 the varnish is cured and the substrate 16 with the cured and smoothened varnish layer 102 leaves the cylinder 42. Using this applied-film technique, it should even be possible to produce holographic effects.

The gloss effect obtainable with the inventive process is demonstrated by the following example, where a substrate in the form of a board with a grammage of 240 g/m² was coated with a layer of UV-curable solvent-based acrylate varnish applied with a thickness in the region of 4 to 8 g/m², smoothened and cured as described as above, top printed with a silver-based high-gloss metallic paint and optionally overprinted with an additional layer of solvent-based varnish. Comparatively, the substrate was directly printed with the silver-based metallic paint. The gloss of the outer surfaces was measured with a Zehntner ZGM 1120 reflectometer set at an incidence angle of 60°. The results are tabulated in Table 1.

TABLE 1

| Specimen | Gloss (points) | |
|---|---|---|
| Comparative, metallic ink | 69.8 | (average of 3) |
| on substrate | | |
| Inventive, smooth varnish | 343 | (average of 3) |
| printed with metallic ink and | | |
| topcoated with varnish | | |
| Inventive, smooth varnish | 451 | (single measurement) |
| printed with metallic ink | | |
| without topcoat | | |

According to the present discussion, it should be appreciated that the principles of the present teachings provide benefits over conventional foil stamping processes and also over applications intended to achieve a simulated foil/metalized solution or foil/metalized alternative, such as transfer metalized board or vacuum metalized PET, laminated on board, and other techniques.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A process for forming a printed product, said process comprising:
(a) applying a hardenable varnish to a sheet-like substrate at a first printing station to form a non-hardened layer of hardenable varnish on the substrate, said layer of varnish having an outermost surface relative to the substrate;
(b) conveying the substrate with the layer of varnish to a hardening device where said outermost surface of the varnish is applied against a smooth polishing surface of the hardening device that conforms to said outermost surface of the layer of varnish and smoothens said outermost surface of the layer of varnish applied to the substrate during its passage through the hardening device;
(c) hardening the layer of varnish, the hardening being accomplished during at least a portion of its passage though said hardening device;
(d) conveying the substrate with its applied hardened layer of varnish that is smoothened on said outermost surface to a second printing station; and
(e) at the second printing station, applying metalized ink by a printing process to said smoothened outermost surface of the layer of varnish applied on the substrate.

2. The process according to claim 1, wherein the substrate is paper or board.

3. The process according to claim 1, wherein the hardenable varnish is energy-hardenable varnish, namely an EB- or UV-curable varnish that is hardened by being cured respectively by applying an electron beam or ultra-violet radiation.

4. The process according to claim 1, wherein the substrate and its applied varnish layer are passed around a cylinder at the hardening device, said cylinder having a smooth polishing outer surface against which said outermost surface of the varnish layer is applied to smoothen it as it passes around the cylinder.

5. The process according to claim 4, wherein the varnish is an energy-hardenable varnish, an energy source for applying energy to harden the varnish layer is located inside or beside said cylinder which is transparent to the applied energy and wherein the energy is applied to the layer of varnish through the cylinder.

6. The process according to claim 4, wherein an energy source for applying energy to harden the varnish layer is located outside said cylinder, the varnish is an EB-curable varnish and wherein electron beam radiation is applied to the layer of varnish from outside through the substrate.

7. The process according to claim 1, wherein the substrate and its applied varnish layer are passed around a cylinder at the hardening device with said outermost surface of the varnish layer located outside relative to the cylinder, and wherein a smooth film is applied to the outside of said outermost surface of the varnish layer to smoothen it.

8. The process according to claim 7, wherein the smooth film is applied against said outermost surface by rollers located substantially diametrically of the cylinder and between said rollers the smooth film is held against said outermost surface by tension.

9. The process according to claim 7, wherein the varnish is an energy-hardenable varnish, an energy source for applying energy to harden the varnish layer is located outside said cylinder and wherein the energy is applied to the layer of varnish from outside through said smooth film.

10. The process according to claim 1, wherein the varnish is an energy-hardenable varnish,
a first energy source for applying energy to partly harden the varnish layer is located before calandaring in the hardening device, and
a second energy source for applying energy to fully harden the varnish layer is located after the calandering in the hardening device.

11. The process of claim 1, wherein a further layer of varnish or ink is printed on top of the applied metallic ink, at a third printing station.

12. The process according to claim 1 wherein the step of hardening the layer of varnish comprises at least partially hardening immediately upstream of said hardening device or at least partially hardening to complete hardening immediately downstream of said hardening device.
